(19) United States
(12) Patent Application Publication
(10) Pub. No.: US 2019/0321142 A1
(43) Pub. Date: Oct. 24, 2019

(54) DENTAL IMPLANT

(71) Applicant: Jong-pil KIM, Gyeongsangbuk-do (KR)

(72) Inventor: Jong-pil KIM, Gyeongsangbuk-do (KR)

(21) Appl. No.: 16/388,108

(22) Filed: Apr. 18, 2019

(30) Foreign Application Priority Data
Apr. 19, 2018 (KR) 10-2018-0045832

(51) Int. Cl. A61C 8/00

(52) U.S. Cl. CPC A61C 8/0068; A61C 8/0069; A61C 8/006

(57) ABSTRACT

A dental implant includes a fixture, an abutment, and a male screw. The fixture includes a lower part, which includes a screw portion and is to be inserted into alveolar bone, an intermediate part which is to come into contact with gingiva, and an upper part which partially or entirely protrudes from the gingiva when the implant is implanted and is coupled with a dental prosthesis. Particularly, a polygonal protruding portion is provided at a top of the upper part of the fixture, which protrudes from the gingiva, and a polygonal insertion portion, into which the polygonal protruding portion is inserted, is formed at a bottom of the abutment coupled with the fixture.

### CROSS-REFERENCE TO RELATED APPLICATION

This application claims priority to and the benefit of Korean Patent Application No. 2018-0045832, filed on Apr. 19, 2018, the disclosure of which is incorporated herein by reference in its entirety.

### BACKGROUND

### 1. Field of the Invention

The present invention relates to a dental implant, and more particularly, to a dental implant in which an implant can be easily implanted in an alveolar bone of a patient by improving structures of a fixture and an abutment, the implant and the alveolar bone can be firmly coupled with each other after a procedure, and excellent hygienic conditions can be maintained in a treatment area.

### 2. Discussion of Related Art

A dental implant functions as a natural tooth due to an artificial tooth being implanted into gingiva and an alveolar bone and is inserted into the alveolar bone instead of a missing tooth. Here, a fixture formed of a metal such as titanium and the like, which is not rejected in a human body, is inserted into the alveolar bone and then a dental prosthesis (artificial tooth or crown) is coupled with and fixed to a top thereof so as to replace a function of the tooth.

A metal such as titanium is used for a dental implant. Titanium has a property of being firmly coupled to the alveolar bone without damage to the alveolar bone or gingiva when being coupled with the alveolar bone and tooth decay not occurring in titanium after a long lapse of time from a procedure. Accordingly, due to a variety of causes described above, dental implants have been a very advantageous treatment method for patients who are missing teeth.

Since dental implants are manufactured to have structures similar to those of teeth, pain in gingivae or foreign body sensation is hardly present such that the pleasure of eating is provided to patients to improve the quality of their lives. Accordingly, dental implants are generally used for the purpose of semipermanently replenishing missing teeth.

Implants may be manufactured in a variety of shapes and may be classified as one-piece implants, two-piece implants, and three-piece implants depending on the number of components forming an implant.

A one-piece implant is manufactured by implanting an implant including a single component into an alveolar bone and then processing an abutment provided on a top thereof. Here, a fixture and the abutment are integrally formed and implanted into the alveolar bone such that problems such as loosening and fracture of a screw and poor cleanliness do not occur. However, since a length of the implant is long, it is difficult to perform an implanting procedure.

Particularly, in the case of a patient who is not able to open his or her mouth widely, it is more difficult to perform an implanting operation. Also, since an external force such as an occlusal force and the like is directly applied right after implantation, it is unfavorable for osseointegration between the alveolar bone and the fixture.

In the case of two-piece implants, since a screw is formed at an abutment, it is necessary to fasten a fixture to the abutment by rotating the abutment like a screw. Accordingly, when only one implant is inserted, since a structure for resisting reverse rotation, that is, loosening of the abutment, is not present, the screw of the abutment is easily loosened such that a dental prosthesis also shakes sometimes. In the case of two-piece implants, when two dental prostheses are integrally mounted on two implants, abutments may be prevented from being loosened. However, when the dental prostheses are firmly fixed to the implants using cement and it is necessary to temporarily remove the dental prosthesis for repairs, in most cases, it is impossible to remove the dental prostheses without damage thereto.

A three-piece implant includes a fixture, an abutment, and a screw and is generally used in one or a plurality of implants. The most used products are mostly implants formed of three pieces. A three-piece implant is generally embedded by using a method in which a fixture is inserted into an alveolar bone and then is coupled with an abutment using a screw and the like after the fixture is firmly embedded into the alveolar bone (osseointegration).

When a two-piece implant or a three-piece implant is used for an implant procedure, in most implants, a fixture and an abutment are coupled with each other at a position of a gingival line (a line connecting exteriors of gingivae) or below the gingival line (refer to FIG. 8A). When the fixture and the abutment are coupled with each other above the gingival line, an undercut (space under eaves) is formed under a gingiva contact portion 12 below a dental prosthesis such that a black triangle (triangular space) is formed between gingiva and the dental prosthesis after the dental prosthesis is mounted. Accordingly, a metallic part of the gingiva contact portion 12 is exposed outward such that aesthetics are poor and a side effect, in which pieces of food are inserted therein, occurs.

Meanwhile, among patients who are subjects of an implanting procedure, in the case of patients whose alveolar bone has a narrow width or a small height, it is difficult to perform an implanting procedure and to firmly maintain an implant.

In conventional techniques, for example, as disclosed in Korean Patent Publication No. 10-2007-0053503 (published on May 25, 2007, hereinafter, referred to as “Conventional Technique 1”) (refer to FIG. 1 or FIGS. 4, 8, 11, and the like of the corresponding published patent), a fixture is generally formed to a gingival line (line formed by tope ends of gingivae) or formed therebelow. In other conventional techniques, a fixture is generally formed to a position close to a top end of an alveolar bone.

In the case of implants in which a fixture is formed to a gingival line, formed therebelow, or formed to a top end of an alveolar bone, an upper structure (abutment) is coupled with a top thereof, and then a dental prosthesis is only attached to the abutment as in the above-described conventional techniques, side effects such as loosening of a screw, and fracturing of the screw, the abutment, or the fixture frequently occur. Since the fixture is covered by the gingiva or deeply embedded in the gingiva such that a connecting portion is not seen when the abutment is connected to the fixture, it is difficult to perform a connecting operation. Also, when being used for a long time after a procedure, pieces of food are inserted in a gap between the dental prosthesis and the abutment or a gap between the abutment and the fixture, or bacteria increase therebetween such that halitosis occurs and periodontitis occurs near a procedure area.

As another conventional technique, Korean Patent Registration No. 10-0997553 (filed on Jun. 10, 2010 and registered on Nov. 24, 2010, hereinafter, referred to as “Conventional Technique 2”) relates to an integral implant in which a part corresponding to a fixture of an implant is formed vertically lengthwise, a gingiva coupling portion, which is a part coupled with gingiva, is formed above a bone insertion portion, and a prosthetic coupling portion (a designation such as “prosthetic coupling portion” is used in this technique), which is coupled with a dental prosthesis (a crown), is formed above the gingiva coupling portion (refer to FIG. 2). Accordingly, in the case of Conventional Technique 2, since the dental prosthesis is coupled with a top of a gingival line, the sanitary issues of teeth in Conventional Technique 1 are considerably removed. However, since Conventional Technique 2 is applied to an integral implant which is similar to a one-piece implant, it is difficult to directly apply it to generally used three-piece implants and it is difficult to perform a procedure. Also, since a high occlusal force is directly applied to a fixture right after the procedure, the problem of integral implants (one-piece implants), which is unfavorable for osseointegration, is still present. Also, since the prosthetic coupling portion is long, in most cases, it is possible to perform prosthetic treatment without a prosthetic extension portion.

Meanwhile, Korean Patent Registration No. 10-1087921 (filed on Jun. 23, 2009 and registered on Nov. 22, 2011, hereinafter, referred to as “Preceding Patent”), which is filed by the applicant and registered, relates to a three-piece implant (refer to FIG. 3) in which an upper part of a fixture partially protrudes from gingiva to the outside such that the fixture and an abutment are coupled with each other at a position above a gingival line. In the Preceding Patent, since a top of the fixture and the abutment protrude from the gingival line through the above components, it is easy to connect the fixture to the abutment simultaneously while a permanent dental prosthetic is attached to the upper part of the fixture and the abutment together so as to improve stability of a structure and sanitary issues of the dental prosthesis and increase efficiency of an implanting procedure.

### DOCUMENTS OF RELATED ART

### Patent Documents

(Patent Document 0001) Korean Patent Publication No. 10-2007-0053503 (published on May 25, 2007)

(Patent Document 0002) Korean Patent Registration No. 10-0997553 (filed on Jun. 10, 2010 and registered on Nov. 24, 2010)

(Patent Document 0003) Korean Patent Registration No. 10-1087921 (filed on Jun. 23, 2009 and registered on Nov. 22, 2011)

### SUMMARY OF THE INVENTION

The present invention is directed to providing a dental implant in which structures of a fixture and an abutment used therein are improved to significantly increase efficiency and usability of an implanting procedure, firmly maintain the implant into an alveolar bone, and solve sanitary issues of a subject of an implanting procedure. That is, the structure of the fixture, and particularly, a shape and a structure of a part where the fixture and the abutment are coupled with each other are improved and components of the fixture and an alveolar bone coupling portion are improved to solve problems of conventional techniques.

The present invention is also directed to more easily performing an implanting operation while maintaining advantages of the preceding patent filed by the applicant, which has been described above. That is, the present invention is also directed to providing a dental implant in which an abutment and a fixture are coupled with each other at a position protruding above a gingival line while a polygonal protruding portion formed at an upper part of the fixture is coupled with a polygonal insertion portion formed at a bottom end of the abutment. Accordingly, in comparison to conventional techniques, since it is very easy to secure a view of a treatment area, a load of an implanting procedure may be significantly reduced and bacteria and the like may be prevented from penetrating into a connecting portion between the abutment and the fixture after the implanting procedure so as to significantly reduce occurrences of inflammation and halitosis in an oral cavity.

The present invention is also directed to easily performing a dental implant by adequately adjusting a length of an upper part of a fixture or an abutment according to a structure and a size of teeth of a patient who receives an implanting procedure.

The present invention is also directed to providing a dental implant in which a diameter of a dental root body of a lower part of the fixture may be designed to be small by removing an empty space inside a lower part of the fixture since it is possible to adequately bear an occlusal force of teeth which is applied to the implant even when a screw hole, into which a male screw that is means for coupling a fixture with an abutment, is formed at only a part of the fixture (position higher than those of conventional techniques). Also, a screw thread of a screw portion which is coupled with an alveolar bone may be formed to be higher such that the implant may be firmly coupled with the alveolar bone using the fixture having a small size.

According to an aspect of the present invention, there is provided a dental implant in which an improved fixture is provided and a structure of a part where the fixture is coupled with an abutment to easily insert the abutment into a top of the fixture simultaneously while the fixture and the abutment are firmly coupled with each other such that the implant having a smaller size than those of conventional techniques is used simultaneously while coupling between the fixture and an alveolar bone may be firmly maintained.

A polygonal protruding portion may be formed at a top end of a dental prosthesis coupling portion of an upper part 10c of the fixture, which is formed outside a gingival line, and a polygonal insertion portion is formed at a bottom end of the abutment which is coupled with the fixture so as to precisely insert the polygonal protruding portion into the polygonal insertion portion.

Since it is possible to decrease a diameter and a size of a dental root body, which is inserted into the alveolar bone due to the above components, effects equal or similar to those of conventional techniques may be achieved using the implant having the smaller size than those of conventional techniques.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating a conventional technique;

FIG. 2 is a view illustrating another conventional technique;

FIG. 3 is a view of a prior patent invented by the applicant;

FIG. 4 is an exploded view of a dental implant according to an embodiment of the present invention;

FIGS. 5A to 5C illustrate fixtures according to embodiments of the present invention in top views and side views;

FIGS. 6A and 6B are an exploded perspective view and a coupled perspective view illustrating an implant according to an embodiment of the present invention;

FIGS. 7A and 7B illustrate examples of a procedure in which the implant according to the embodiment of the present invention is applied;

FIGS. 8A to 8C are state diagrams in which fixtures according to conventional techniques and a fixture according to an embodiment of the present invention are implanted in alveolar bones;

FIGS. 9A and 9B illustrate abutments according to embodiments of the present invention;

FIGS. 10A to 10C illustrate examples of a shape of a top surface of a screw head according to an embodiment of the present invention; and

FIGS. 11A to 11D illustrate implants according to embodiments of the present invention.

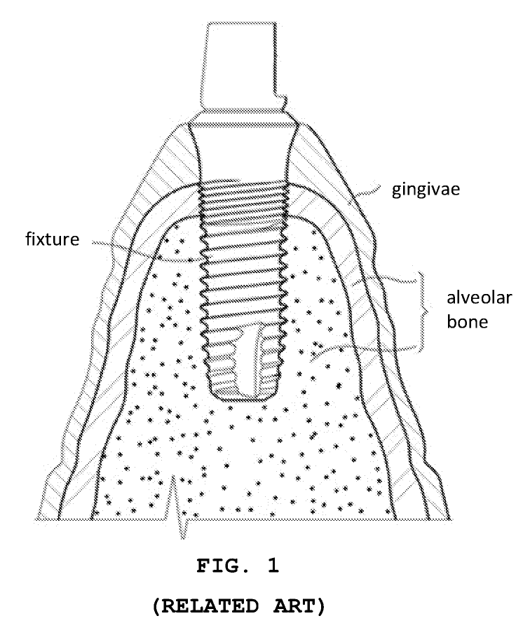

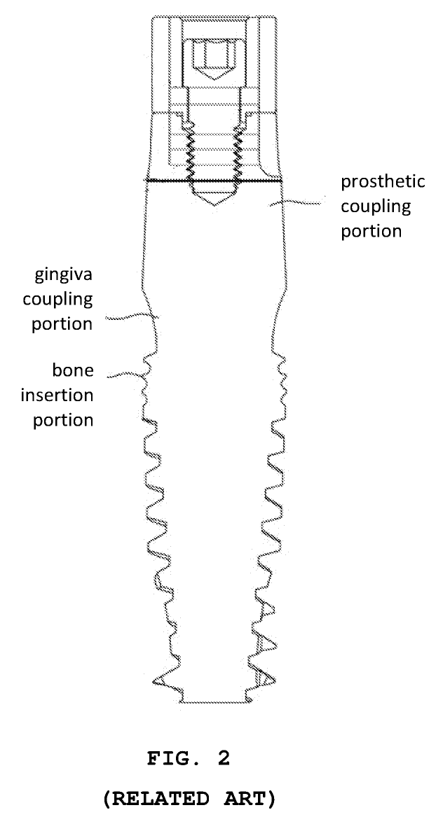

### DETAILED DESCRIPTION OF EXEMPLARY EMBODIMENTS

Components for achieving aspects and effects of the present invention will be understood through a description on embodiments of the present invention and attached drawings related thereto.

A dental implant 100 according to an embodiment of the present invention relates to a three-piece implant which includes a fixture 10, an abutment 20, and a male screw 30 as shown in FIGS. 4, 6, and 7A and 7B.

First, components of the fixture 10 will be described in detail.

The fixture 10 includes a lower part 10a, an intermediate part 10b, and an upper part 10c. The lower part 10a is a part which is inserted into an alveolar bone 1. The intermediate part 10b is a part which comes into contact with gingiva. The upper part 10c indicates a part which partially or entirely protrudes from the gingiva to the outside.

The lower part 10a includes a dental root body 11 and a screw portion 11-1. The dental root body 11 forms a central part of the lower part 10a. The screw portion 11-1 is provided outside the dental root body 11 and includes a screw to be coupled with the alveolar bone 1. The dental root body 11 may be manufactured to have a variety of shapes such as a cylindrical shape, a conic shape, and the like. The screw portion 11-1 may be manufactured according to a shape of the dental root body 11 or may be manufactured with an adequate option according to a shape, a size, or density of an alveolar bone of a subject of an implanting procedure.

The intermediate part 10b is a part where an implant and a gingiva 2 come into contact with each other, that is, where a gingiva-contact portion 12 that comes into contact with the gingiva 2 formed of tissue covering the alveolar bone 1 is formed.

The gingiva contact portion 12 may be a contact surface having a vertically cylindrical upper part and a downward tapered soft curved lower part as shown in FIG. 7A or may be a contact surface having a shape in which an end point of a prosthetic margin 18 is connected to the dental root body 11 by a line or a curve as shown in FIG. 7B. A screw hole 16, into which the male screw 30 (e.g., fixing bolt) is insertable, is formed in a part or an entirety of a center of the intermediate part 10b.

The upper part 10c is a part which partially or entirely protrudes from a gingival line to the outside while forming a part of the fixture 10 and includes a dental prosthesis coupling portion 13, a top surface 14, a polygonal protruding portion 15, and the prosthetic margin 18. In a central part of the upper part 10c, the screw hole 16 where an internal thread 17 is formed is provided. Here, a case in which the entire upper part is exposed from the gingival line to the outside indicates a case in which an outer end line of the prosthetic margin 18 coincides with the gingival line.

The polygonal protruding portion 15 is formed at an uppermost end of the fixture 10 and corresponds to a particular component of the present invention. The polygonal protruding portion 15 is a part of a polygon formed on a top end of the top surface 14, and the screw hole 16, through which an external thread 32 of the male screw 30 (e.g., fixing bolt) can pass, is formed in a central part thereof (refer to FIGS. 4, 5A-5C, 6A, 6B, 7A, 7B and 8A to 8C). The polygonal protruding portion 15 may have a hexagonal shape, a quadrangular shape, a pentagonal shape, an octagonal shape, or the like as shown in FIGS. 5A to 5C which illustrate top views and side views of the fixture or may have a shape similar thereto such that a mount is connected to the polygonal protruding portion 15 and is rotated using a wrench or a wrench driver to implant the fixture into the alveolar bone. The polygonal protruding portion 15 is formed on an upper part of the dental prosthesis coupling portion 13, which forms a part of the fixture 10 and protrudes from the gingiva to the outside, and is exposed to be easily observable during dental treatment. Accordingly, while the fixture 10 is inserted into the alveolar bone 1 using the components of the present invention, when the fixture 10 is rotated by holding a wrench driver and the like on the mount connected to the polygonal protruding portion 15, the lower part 10a may be easily inserted into the alveolar bone 1.

The screw hole 16 for inserting the external thread 32 of the male screw 30 therein is formed in a part of the fixture 10. Here, the screw hole 16 may be formed to start from the polygonal protruding portion 15, pass through the upper part 10c, and reach the intermediate portion 10b. In the present invention, the screw hole 16 is configured to be generally formed in a part or the entirety of the intermediate portion 10b having a larger diameter than that of the dental root body 11. However, the present invention does not exclude the screw hole 16 from being formed even in a part of a top end of the dental root body 11. The internal thread 17, where the external thread 32 of the male screw 30 is insertable and rotatable, is provided at the screw hole 16.

Also, the upper part 10c includes the dental prosthesis coupling portion 13 which is one of the other particular components of the present invention. In a general implant, a dental prosthesis coupling portion refers to a part where a component of an implant is coupled with a dental prosthesis formed to be similar to a tooth. In the present invention, the dental prosthesis coupling portion 13 is a part which is formed on an upper part of a fixture and coupled with dental prosthesis.

In the present invention, the dental prosthesis coupling portion 13 is a component which occupies a large part of the upper part 10c and may be manufactured to have a tapered cylindrical shape having a diameter gradually increasing from top to bottom as shown in FIGS. 4, 5, 11C, and 11D or may be manufactured to have a cylindrical shape having the same diameter at top and bottom as shown in FIGS. 11A and 11B.

A vertically cylindrical dental prosthesis coupling portion 13 may be manufactured to include an inclined surface 13-3 formed at a top thereof as shown in FIG. 11A or may be manufactured to exclude an inclined surface as shown in FIG. 11B. The inclined surface 13-3 is a plane which connects an outer surface (part corresponding to an outside of a cylinder) of the vertically cylindrical dental prosthesis coupling portion 13 to the top surface 14. And the inclined surface 13-3 indicates a boundary of the dental prosthesis coupling portion 13 corresponding to a bottom surface 25 of the tapered abutment 20 when the abutment 20 is coupled with the dental prosthesis coupling portion 13.

Meanwhile, when the vertically cylindrical dental prosthesis coupling portion 13 is used as shown in FIGS. 11A and 11B, after the fixture is implanted into an oral cavity of a subject of an implanting procedure, in consideration of a position of a gingival line and a direction of implanting the fixture, the dental prosthesis coupling portion 13 or the abutment 20 may be selectively processed or both the dental prosthesis coupling portion 13 and the abutment 20 may be processed according to teeth of the subject on which the implanting procedure is performed.

It is possible to select and use the dental prosthesis coupling portion 13 which has an adequate size for a shape and a size of teeth of the subject on which the implanting procedure is performed.

In the case of the present invention, a dental prosthesis 3 is attached to both the dental prosthesis coupling portion 13 and an outer circumferential surface 26 of the abutment. Here, when the dental prosthesis 3 is used for a long time after an implant, it may be necessary to repair the implant due to released screws, odontoclasis of an abutment or a fixture, a periodontal disease, or the like. Also, it may be necessary to separate the dental prosthesis 3 from the dental prosthesis coupling portion 13 or to remove the dental prosthesis for repair.

In implant treatment, a cement bonding method is generally used for bonding a dental prosthesis to a dental prosthesis coupling portion. Here, when a length of the dental prosthesis coupling portion (bonding portion) is equal to or shorter than 1 mm, the dental prosthesis may be easily removed, but coupling stability of the dental prosthesis decreases too significantly to be used for a long time. When the length of the dental prosthesis coupling portion (bonding portion) is equal to or longer than 3 mm, a coupling force between the dental prosthesis and the dental prosthesis coupling portion is too strong to remove a cement-bonded dental prosthesis such that it is difficult to repair the implant. Accordingly, a length of the dental prosthesis coupling portion 13, which is adequate for the present invention, may be equal to or longer than 1 mm and shorter than 3 mm. In the case of a one-piece implant, in order to stably retain a dental prosthesis, it is necessary to form a dental prosthesis coupling portion having a length equal to or longer than 3 mm. In the technique of the present invention, which is applied to three-piece implants, it is possible to most effectively implant and repair an implant when the length of the dental prosthesis coupling portion 13 is set within the above range.

An inclined surface 13-1 or a concave groove 13-2 may be formed on an outer circumferential surface of a side surface of the dental prosthesis coupling portion 13 as shown in FIG. 5C. The inclined surface 13-1 or the concave groove 13-2 may be filled with a dental prosthesis forming material such that a part thereof allows the dental prosthesis and the dental prosthesis coupling portion 13 to be integrated with each other. Accordingly, the dental prosthesis 3 may be prevented from rotating, and stability of the dental prosthesis 3 may be secured. Also, the inclined surface or the concave groove may be used for holding the wrench driver and rotating the fixture to implant the fixture into the alveolar bone.

The prosthetic margin 18 refers to a limit part where the dental prosthesis 3 (e.g., a crown) is formed while an implant is implanted and is formed at a position which generally coincides with the gingival line or is therebelow slightly (toward the alveolar bone). The prosthetic margin 18 may be manufactured to have a flat shape (as shown in FIGS. 5A or 5C) which coincides with the gingival line or an upwardly tapered shape (as shown in FIG. 5B) near the gingival line and generally have a width of 0.5 to 1 mm. Meanwhile, as shown in FIGS. 11A and 11B, where the dental prosthesis coupling portion 13 has a cylindrical shape, first, the fixture and the abutment are installed, and then the prosthetic margin 18 may be formed by selectively processing the dental prosthesis coupling portion 13 or the abutment or processing both the dental prosthesis coupling portion 13 and the abutment 20, and thereafter, the dental prosthesis 3 may be attached thereto to implant an implant.

In the present invention, the male screw 30 fixes and couples the fixture 10 and the abutment 20 to and with each other. The male screw 30 passes through a circular hole 22 formed at a lower part of the abutment 20 and then is rotationally inserted into the screw hole 16 provided in the fixture 10 so as to firmly couple the fixture 10 to the abutment 20.

In the present invention, the screw hole 16 is formed through the upper part 10c and the intermediate part 10b. Here, the dental prosthesis coupling portion 13 significantly protrudes such that a coupling force between the fixture 10 and the abutment 20, which is equal to that of a conventional technique, may be secured even when the internal thread 17 is not formed through the dental root body 11 (corresponding to a central part of a root of the fixture) of the fixture 10. That is, the coupling force equal to or greater than that of a conventional technique may be secured by forming the screw hole 16 only in parts or the entirety of the upper part 10c and the intermediate part 10b which have relatively large diameters in comparison to the dental root body 11 (refer to FIGS. 7A and 7B).

Meanwhile, in the present invention, the screw hole 16 is basically formed in the entirety of the upper part 10c and a part or the entirety of the intermediate part 10b. As necessary, the screw hole 16 may be formed to extend toward a part of the dental root body 11 of the lower part 10a, which is adjacent to the intermediate part 10b. That is, in the case of a patient who has a small coupling force of the alveolar bone 1 and has a alveolar bone structure in which it is difficult to secure an adequate space for the upper part 10c and the intermediate part 10b, it may be necessary to form the screw hole 16 toward an upper part of the dental root body 11.

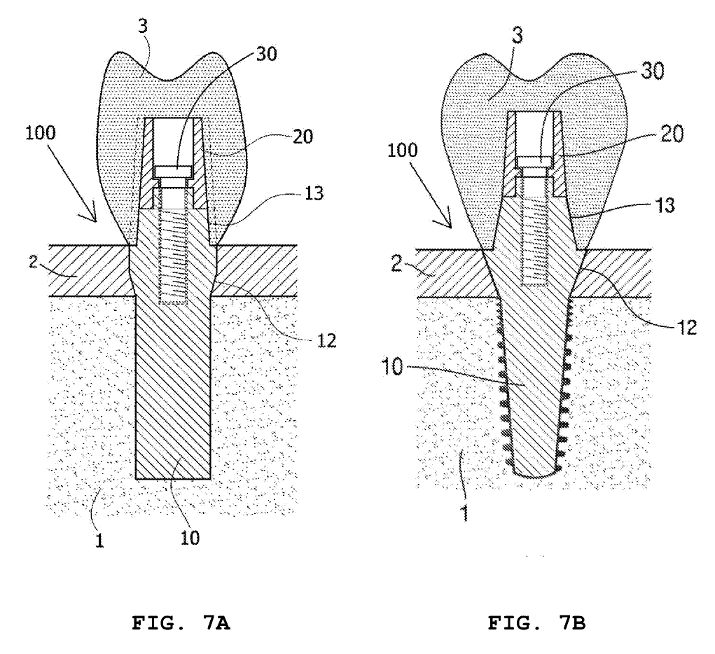

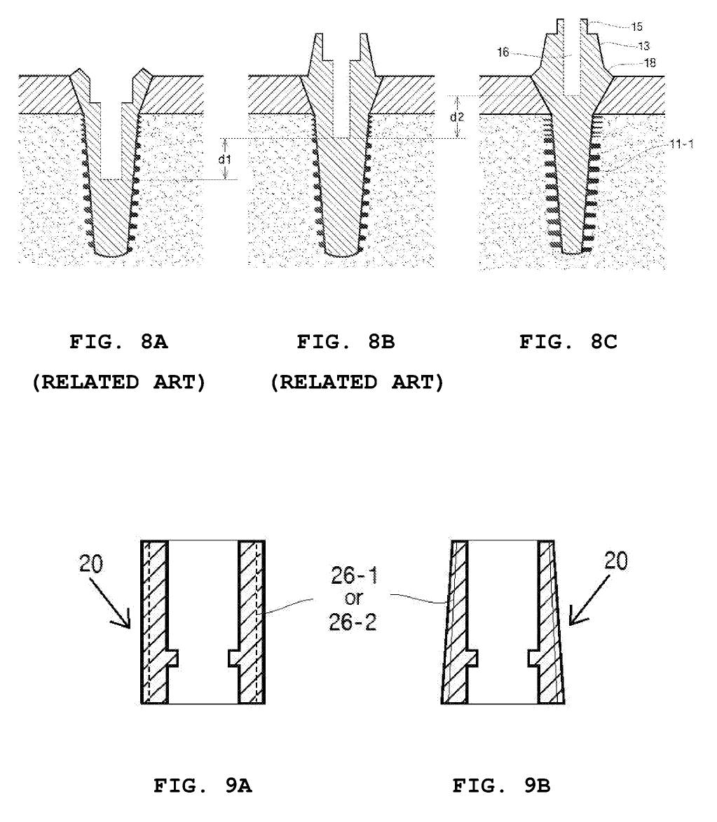

In most cases, since it is unnecessary to form the screw hole 16 to the dental root body 11 of the fixture due to the above-described cause, it is possible to reduce a size and particularly a diameter of the dental root body 11. Accordingly, it is possible to utilize an available space formed due thereto as a space for the screw portion 11-1. Accordingly, as shown in FIG. 8C, the diameter of the dental root body 11 may be small (e.g., thin) and a screw thread of the screw portion 11-1 may be formed to be higher or deeper in comparison to conventional techniques such that the fixture 10 may more firmly adhere to the alveolar bone 1.

FIGS. 8A to 8C are state diagrams in which fixtures according to conventional techniques and the fixture according to the embodiment of the present invention are implanted in alveolar bones. In the present invention, in comparison to conventional techniques, a significant difference is present in upper and lower positions of a hole (e.g., a screw hole) in which a screw is inserted. The drawings illustrate a case in which it is presupposed that screws having the same length are used in both the conventional techniques and the present invention, and thus the screw hole 16 having the same length is used in each thereof.

In the case of a conventional technique shown in FIG. 8A, since most of the screw hole is formed in the dental root body 11 of the fixture, it is impossible to form a small diameter of the dental root body 11 due to the screw hole. In the case of another conventional technique shown in FIG. 8B, although a difference is present in a depth of the screw hole, which is as long as a length dl in comparison to the above-described conventional technique shown in FIG. 8A, the screw hole is still formed in a considerable part of the dental root body 11 such that there is present a limit in reducing a diameter, and particularly, an upper diameter of the dental root body 11 even in this case.

Meanwhile, in the case of the fixture according to the present invention shown in FIG. 8C, the screw hole 16 is formed to only the intermediate part 10b (the gingiva contact portion), and a difference occurs in a depth of the screw hole, which is as long as a length d2 in comparison to FIG. 8B. That is, the screw hole 16 according to the present invention is formed at a position of the fixture, which is as high as d1+d2 in comparison to FIG. 8A and as high as d2 in comparison to FIG. 8B.

Accordingly, in the case of the present invention, unlike the conventional techniques, the screw hole is formed only to the part which does not reach the dental root body 11 such that it is possible to design the diameter of the dental root body 11 regardless of the screw hole 16 and to freely design a diameter and a length within a range capable of enduring an occlusal force of teeth. Also, due to the above difference, a difference occurs in the depth of the screw hole, which is as much as d1+d2 or d2, in comparison to the conventional techniques. Due to the difference, it is possible to adequately design the dental root body 11 and the screw portion 11-1 of the fixture 10. That is, in FIG. 8C, the dental root body 11 having a smaller diameter in comparison to that of FIG. 8A or 8B may be used.

However, as described above, in the present invention, as necessary, the screw hole 16 may be formed to extend toward a part of the dental root body 11 of the fixture, which is adjacent to the intermediate part 10b.

Next, components of the abutment 20 according to the present invention will be described in detail.

As shown in FIGS. 4, 6, and 7, the abutment 20 according to the present invention includes, as components coupled with the fixture from above the fixture 10, the polygonal insertion portion 21, the circular hole 22, a holding lip 23, a circular upper groove 24, and the bottom surface 25. The polygonal insertion portion 21 is formed at the bottom end of the abutment 20. Here, the polygonal insertion portion 21 has a size and a shape in which the polygonal protruding portion 15 of the upper part 10c of the fixture 10 is precisely insertable. The circular hole 22, through which the external thread 32 of the male screw 30 is passable, is formed above the polygonal insertion portion 21, and a diameter of the circular hole 22 is smaller than a diameter of the circular upper groove 24. Due to the hole, the holding lip 23, which protrudes toward an inside of the abutment 20, is formed. The holding lip 23 is a part by which a head 31 of the male screw 30 is held so as to not enter while the male screw 30 passes the circular upper groove 24 and is inserted into the screw hole 16 of the fixture 10. That is, when the fixture 10 and the abutment 20 are coupled using the male screw 30, the head 31 of the male screw 30 is held by the holding lip 23 first and the fixture 10 and the abutment 20 are firmly coupled to each other by rotating the male screw 30 in this state.

Meanwhile, the bottom surface 25, which is a plane forming a bottom of the abutment 20, is formed to have the same shape as that of a top surface 14 of the fixture 10 such that the two surfaces may come into closely contact with each other. The bottom surface 25 may be formed as a smooth flat surface and may be formed as a plane to which an elastic material is applied.

The outer circumferential surface 26, which forms a side surface of the abutment 20, may have a vertically cylindrical shape (a structure in which upper and lower diameters of the abutment 20 are equal to each other) as shown in FIGS. 9A and 11B or may have a tapered shape (a structure in which a diameter of the abutment 20 gradually increases toward a bottom thereof) as shown in FIGS. 9B, 11C, and 11D.

Also in the case of the abutment 20, as shown in FIGS. 9A and 9B, an inclined surface 26-1 or a concave groove 26-2 may be formed on the outer circumferential surface 26. The inclined surface 26-1 or the concave groove 26-2 formed on or in the abutment 20 may have a shape which is equal or similar to that of the inclined surface 13-1 or the concave groove 13-2 formed on or in the dental prosthesis coupling portion 13 of the fixture 10 in FIG. 5C. Inclined surfaces or concave grooves formed at the fixture 10 and the abutment 20 may have vertically arranged shapes but are not necessarily arranged. The inclined surface 13-1 or the concave groove 13-2 formed on or in the dental prosthesis coupling portion 13 of the fixture 10 prevents the dental prosthesis 3 from rotating around the dental prosthesis coupling portion 13 and allows the dental prosthesis 3 to be more firmly coupled with the dental prosthesis coupling portion 13 and to simultaneously rotate the fixture 10 by holding a wrench driver and the like thereon. On the other hand, the inclined surface 26-1 or the concave groove 26-2 formed on the outer circumferential surface 26 of the abutment 20 generally prevent the dental prosthesis 3 from rotating around the abutment 20 and help the dental prosthesis 3 to be stably coupled therewith.

Meanwhile, when an implant is manufactured by vertically arranging and filling the inclined surface 13-1 or the concave groove 13-2 formed on the dental prosthesis coupling portion 13 and the inclined surface 26-1 or the concave groove 26-2 formed on the outer circumferential surface 26 of the abutment 20 with dental prosthesis forming materials, a bottom and top of the dental prosthesis coupling portion 13 and the outer circumferential surface 26 are formed to be connected by being filled with the dental prosthesis forming material. Accordingly, when they are integrally formed, the dental prosthesis 3, the abutment 20, and the fixture 10 are more firmly coupled with one another such that effects occur, wherein the abutment 20 does not rotate or move, screw-loosening is prevented, and the male screw 30 and the abutment 20 are prevented from fracturing. The inclined surface or the concave groove may be formed on both the dental prosthesis coupling portion 13 and the outer circumferential surface 26 of the abutment 20 or may be formed on only one of the dental prosthesis coupling portion 13 and the outer circumferential surface 26 of the abutment 20 as necessary.

Next, components of the male screw 30 will be described.

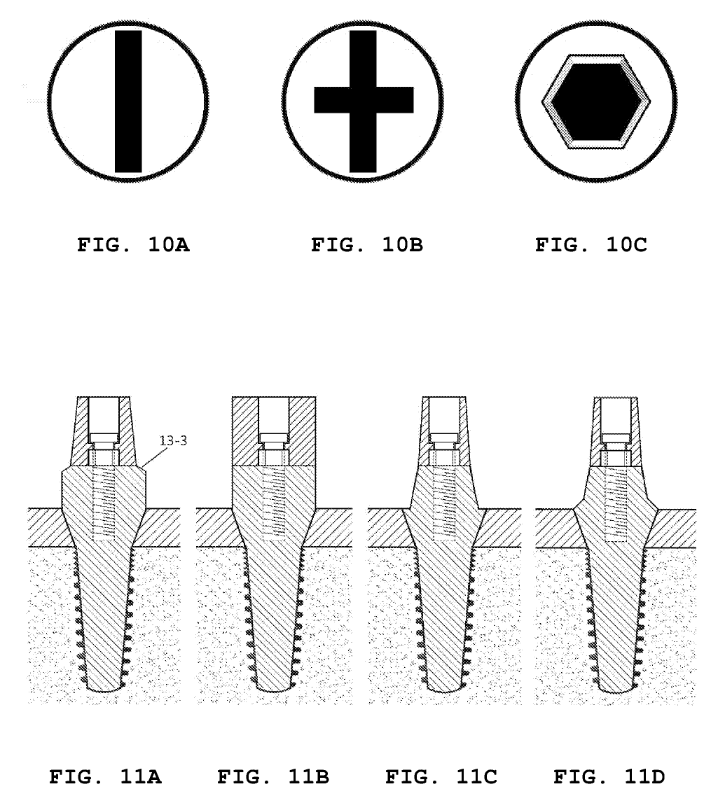

The male screw 30 of the present invention is a means (e.g., a wrench bolt) which couples the fixture 10 with the abutment 20 and includes the head 31 and the external thread 32 as shown in FIG. 4. The head 31 of the male screw 30 has a circular or a circle-like shape, which is insertable in the circular upper groove 24 of the abutment 20, and firmly couples the abutment 20 with the fixture 10 such that they do not move. A groove having a bar shape, a cross shape, a polygonal shape, or a shape similar thereto is formed on a top surface of the head 31, which is for inserting a wrench driver having the same shape thereinto. FIGS. 10A to 10C illustrate examples of a shape of the groove formed on the top surface of the head 31 which is applied to the male screw 30 of the present invention.

The abutment 20 and the fixture 10 may be coupled with each other when a wrench driver having a size fitting the groove formed on the top surface of the male screw 30 is inserted into the groove and rotated and vice versa.

The external thread 32 of the male screw 30 is formed to have a length which passes through the circular hole 22 and the polygonal protruding portion 15 and reaches a bottom end of the screw hole 16 and is adequate for firmly coupling the fixture 10 with the abutment 20. That is, the external screw 32 of the present invention may be manufactured to have a shape and a size which are adequate for fitting an alveolar bone structure and a size of a patient who receives an implanting procedure as shown in FIGS. 4, 5A-5C, 6A, 6B, 7A, 7B and 8C.

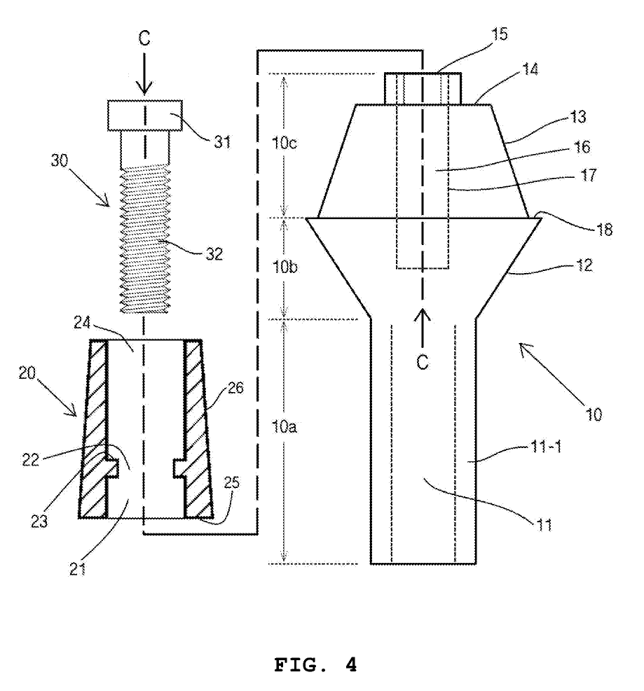

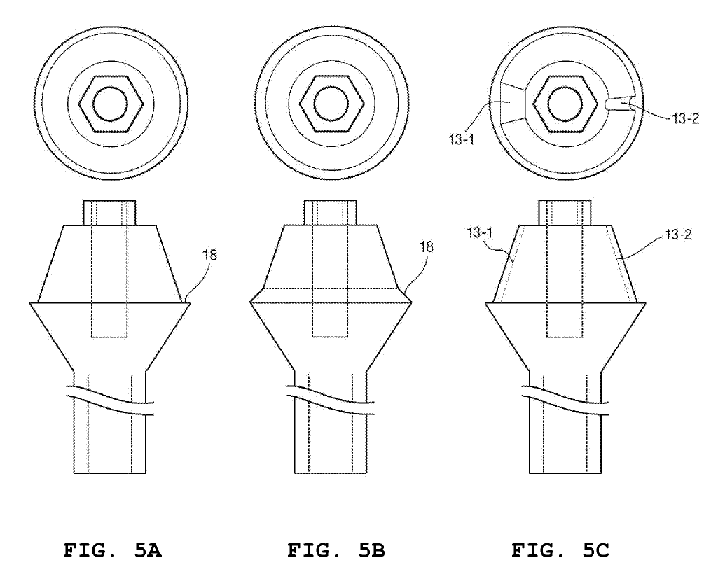

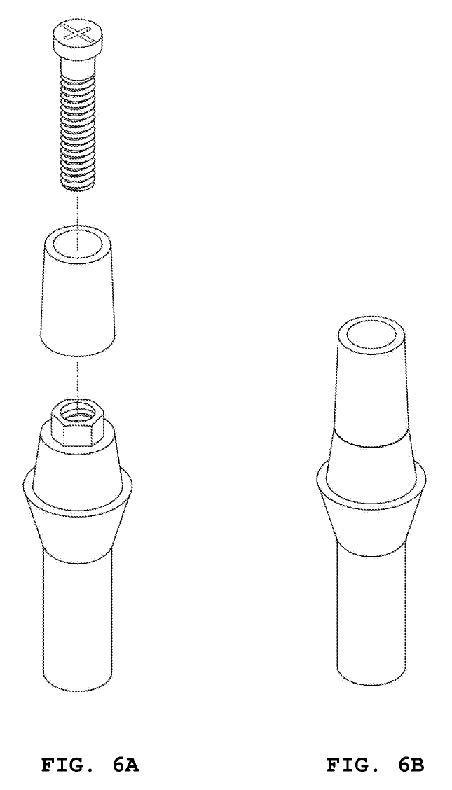

FIGS. 4 and 6A are an exploded view and a perspective view, respectively, of an implant according to one embodiment of the present invention, which includes the fixture 10, the abutment 20, and the male screw 30 which are described above. FIG. 6B is a perspective view of the implant according to the embodiment of the present invention, in which the three components are coupled. Accordingly, referring to these drawings, a structure of the present invention may be more clearly understood.

FIGS. 7A and 7B illustrate states in which the implant according to the technical concept of the present invention is applied.

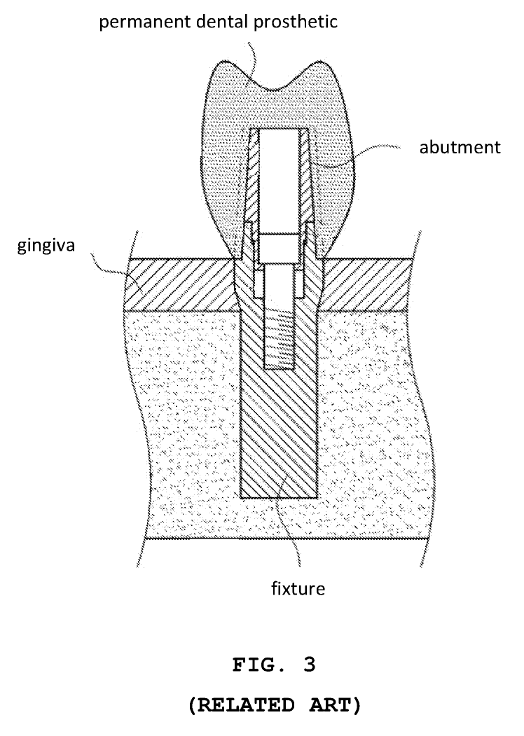

In FIG. 7A, a technique of the present invention is applied to an implant having a shape similar to that of the preceding patent filed by the applicant. Here, in comparison to the preceding patent shown in FIG. 3, a significant difference is present in a depth of the screw hole.

FIG. 7B illustrates another state to which the present invention is applied. In this embodiment, it may be seen that the dental prosthesis coupling portion 13 is formed at a position which is higher than that of FIG. 7A and the screw hole 16 is also formed only to the intermediate part (gingiva contact portion). A case shown in FIG. 7B is applicable to a patient who has relatively larger-sized teeth.

In the two cases shown in FIGS. 7A and 7B, although a partial difference is present in shapes thereof, since the dental prosthesis 3 is attached to the dental prosthesis coupling portion 13 and the abutment 20 in both cases, the implant may provide all effects such as convenience of the procedure, solidity after the procedure, hygienic advantages, and the like.

Also, although only cases in which the prosthetic margin 18 has a flat shape which coincides with the gingival line are shown in FIGS. 7A and 7B, it is possible to apply the prosthetic margin 18 having an inclined shape as shown in FIG. 5B or 8C. The prosthetic margin 18 can coincide with a position of the gingival line or be located below the gingival line so as to not expose the gingiva contact portion 12 of the fixture 10 from the gingivae to the outside such that aesthetics are improved and a space is not formed below the dental prosthesis. When the prosthetic margin 18 is located above the gingival line, the gingiva contact portion 12 of the fixture 10 is exposed from the gingivae to the outside such that a metallic part of the gingiva contact portion 12 is exposed externally and aesthetics are poor. Also, an undercut (space under eaves) is formed under the gingiva contact portion 12 below the prosthetic margin 18. Due to the undercut, a black triangle (triangular space) is generated between the gingivae and the dental prosthesis 3 after the dental prosthesis 3 is mounted such that aesthetics are poor and a side effect, in which food is inserted in the space, occurs.

FIGS. 11A to 11D are views illustrating a variety of embodiments of dental implants to which the present invention is applied.

The implant of the present invention may include the dental prosthesis coupling portion 13 having a vertically cylindrical shape and the abutment 20 having a tapered shape as shown in FIG. 11A, may include the dental prosthesis coupling portion 13 and the abutment 20, both of which have vertically cylindrical shapes as shown in FIG. 11B, and may include the dental prosthesis coupling portion 13 and the abutment 20, both of which have tapered shapes as shown in FIGS. 11C and 11D. Although gingiva contact portions 12 having only a tapered shape are shown in FIGS. 11A to 11D, the gingiva contact portion 12 may have a vertically cylindrical upper part and a tapered lower part as shown in FIG. 7A. Also, the prosthetic margin 18 may have a flat shape which coincides with the gingival line as shown in FIG. 11C or an inclined shape as shown in FIG. 11D.

The present invention has been described in detail on the basis of a case in which an implant is implanted in the gingivae and the alveolar bone of a lower jaw (submaxilla) of an oral cavity. When an alveolar bone, into which an implant is embedded, is located on an upper jaw (maxilla) of an oral cavity, it should be understood in consideration of a direction being changed from the above description.

Anticipated effects of the present invention are present as follows.

In the case of generally used implants, since a connecting part between a fixture and an abutment, i.e., a connecting gap thereof, is not surrounded by dental prosthesis, foreign substances or bacteria may penetrate thereinto. Accordingly, a problem is present in keeping dental prosthesis of the implant clean. However, in the present invention and preceding patent filed by the applicant, a gap of a connecting portion is located inside where the dental prosthesis 3 is mounted and prevents external foreign substances and bacteria from penetrating thereinto so as to significantly reduce occurrences of inflammation and halitosis in an oral cavity.

In the present invention, since the connection portion between the abutment 20 and the dental prosthesis coupling portion 13 of the fixture 10 is located above the gingivae such that a significant part of an occlusal force transferred to the dental prosthesis 3 is distributed to the dental prosthesis coupling portion 13 of the fixture 10, the occlusal force transferred to the abutment 20 and the male screw (e.g., fixing bolt) 30, which are connected thereabove, is far smaller in comparison to general implanting methods such that a possibility of screw-loosening or screw fracture is significantly reduced. An external lateral force applied to the dental prosthesis 3 (crown) is evenly distributed to the abutment 20 and the fixture 10 such that shaking of the abutment 20 is reduced. When the concave groove or the inclined surface of the fixture 10 or the abutment 20 is filled with a dental prosthesis forming material, the fixture 10, the abutment 20, and the dental prosthesis 3 is mutually fastened such that rotation of the dental prosthesis 3 and the abutment 20, which may occur when the external lateral force is applied to the dental prosthesis 3, may be prevented. Accordingly, a phenomenon, in which the male screw 30 is loosened, is reduced such that stability of the dental prosthesis 3 increases.

In a general procedure using the present invention, a mount is connected to the polygonal protruding portion 15 and rotated to implant the fixture 10 into the alveolar bone. In the case of a patient whose resistance to fastening of the fixture 10 is particularly great, the inclined surface 13-1 or the concave groove 13-2 is formed on the dental prosthesis coupling portion 13 and a wrench driver is held to rotate the fixture 10 such that the fixture 10 may be inserted without damage to the fixture 10 or the wrench driver.

When an improved structure of the present invention is used, in addition to the above-described advantages, effects which are distinguished from the preceding patent may be additionally expected as follows.

First, when a procedure is performed using the implant of the present invention, it is possible to insert the fixture 10 into the alveolar bone using the polygonal protruding portion 15 which protrudes from the gingivae to the outside to secure a clear view. Accordingly, convenience and usability of the implant procedure may significantly increase in comparison to not only general treatment methods but also the preceding patent.

Next, as seen through FIGS. 8A to 8C, in a configuration of the present invention, since connecting means formed above the dental prosthesis coupling portion 13 to connect the abutment 20 to the fixture 10 are formed as the polygonal protruding portion 15 instead of a polygonal insertion portion, it is possible to form the screw hole 16 for the male screw (e.g., fixing bolt) 30, which fixes the abutment 20, considerably higher in comparison to not only conventional techniques but also the preceding patent. That is, although the hole 16 is formed in only the upper part 10c and the intermediate part 10b, an implant may be firmly fixed. However, a depth of the screw hole 16 may vary according to conditions of the alveolar bone of the patient.

Also, in the present invention, since an adequate coupling force may be secured between the fixture 10 and the abutment 20 although a position of forming the screw hole 16 does not reach the dental root body 11, a diameter of the dental root body 11 of the fixture 10 may be designed to be relatively small. Also, to this end, an adequate space for the screw portion (screw thread) 11-1, which is coupled with the alveolar bone 1, may be secured and the screw thread of the screw portion 11-1 may be formed to be higher or deeper than those of conventional techniques. That is, strength of the dental root body 11 is significantly increased by removing an empty space inside the dental root body 11 such that it is possible to implant an implant having a coupling force greater than those of conventional techniques using the dental root body 11 having a smaller diameter than those of the conventional techniques. Accordingly, it is possible to implant an implant stably and firmly on an alveolar bone of a patient although it has a narrow width.

Effects expected from the present invention are present as follows. Particularly, the present invention has a structure which is improved from that of Korean Patent Registration No. 10-1087921 which was filed by the applicant.

First, in the present invention, since a connecting part of an abutment and a dental prosthesis coupling portion of a fixture is located at a top thereof which protrudes from gingivae to the outside to distribute an occlusal force transferred to dental prosthesis to the abutment and the dental prosthesis coupling portion as in the preceding patent, the occlusal force transferred to the abutment and a male screw (e.g., fixing bolt), which are connected thereabove, is far smaller than those of general implanting methods such that possibilities of loosening the male screw (e.g., fixing bolt) or screw fracture and abutment fracture may be significantly reduced and a male screw having a smaller diameter may be used.

Next, in the preceding patent and the present invention, since a top of the fixture extends upward, a means (e.g., a polygonal insertion portion or a polygonal protruding portion) for connecting to the abutment formed above the fixture and a screw hole in the fixture for the male screw (e.g., fixing bolt) of the abutment may have a smaller diameter in comparison to that of a fixture of a general implant and may be located far above so as to remove an empty space inside the fixture. Accordingly, strength of the fixture may be significantly increased and a height of a screw thread formed outside the fixture may be increased such that a contact area between the fixture and the alveolar bone increases to further help osseointegration and stability of the fixture.

Also, generally, since a connecting part, that is, a connecting gap between the fixture and the abutment is not surrounded by the dental prosthesis, external foreign substances or bacteria may penetrate therein. Accordingly, a problem is present in keeping a dental prosthesis of an implant clean. However, in the preceding patent and the present invention, a gap of the connecting portion is located inside where the dental prosthesis is mounted to prevent penetration of external foreign substances and bacteria to maintain complete cleanliness.

Also, generally, since the connecting part between the fixture and the abutment is located below gingivae such that it is impossible to see, with the naked eye, a fastening state when the abutment is connected thereto, inconveniences are present. In the preceding patent and the present invention, since the connecting portion of the fixture and the abutment is located above gingivae such that it is possible to easily see, with the naked eye, a fastening state when the abutment is connected thereto, the fixture and the abutment may be simply and completely fastened.

Particularly, in comparison to the preceding patent filed by the applicant, the present invention may have further effects as follows.

That is, for connection to the abutment, a connecting means formed at a top of the dental prosthesis coupling portion of the fixture is formed as a polygonal protruding portion instead of a polygonal insertion portion such that a screw hole, into which an external thread of the male screw for fixing the abutment, may be formed to be considerably higher in comparison to the preceding patent. Also, due thereto, since the screw hole for the male screw (e.g., fixing bolt) for the abutment is not formed in the dental root body (part inserted into the alveolar bone and excluding the screw thread) of the fixture implanted into the alveolar bone, that is, an empty space inside a fixing body is completely removed, it is possible to significantly increase strength of the dental root body 11 such that it is possible to manufacture a three-piece implant which has the dental root body 11 having a smaller diameter. However, it is possible to manufacture a three-piece implant having a large diameter using the technique of the present invention.

In general, a mount is connected to the polygonal protruding portion, which protrudes from the gingivae to the outside, and is rotated to implant the fixture into the alveolar bone. In the case of a patient whose resistance to fastening of the fixture is particularly great, an inclined surface or a concave groove is formed on the dental prosthesis coupling portion and a wrench driver is held to apply a rotation force to the inclined surface or the concave groove such that the fixture may be inserted without damage to the fixture or the wrench driver.

Although the components and effects of the present invention have been described above, the present invention is not limited to the above-described embodiment and may be variously changed or modified without departing from the technical concept and scope of the present invention. Therefore, changes or modifications, which are obvious to one of ordinary skill in the art, should be understood as belonging to the scope of the claims of the present invention.

What is claimed is:

1. A dental implant, comprising:
a fixture comprising a lower part, an intermediate part, and an upper part;
the lower part comprising a dental root body configured to be implanted into an alveolar bone, and a screw portion; wherein
the intermediate part comprises a gingiva contact portion configured to come into contact with gingiva,
the upper part comprises a dental prosthesis coupling portion, a top surface, and a polygonal protruding portion,
the dental prosthesis coupling portion is configured to partially or entirely protrude from the gingiva,
the polygonal protruding portion protrudes from the top surface of the fixture,
a screw hole configured to be coupled with an abutment is formed in central parts of the polygonal protruding portion and the dental prosthesis coupling portion, and
the screw hole is formed along a central axis of the fixture such that the screw hole extends from the polygonal protruding portion to an upper part of the gingiva contact portion.

2. The dental implant of claim 1, wherein the screw hole is formed to pass through central parts of the upper part and the gingiva contact portion and reach a part of the dental root body which is adjacent to the gingiva contact portion.

3. The dental implant of claim 1, wherein the polygonal protruding portion has one of a quadrangular shape, a pentagonal shape, a hexagonal shape, or an octagonal shape.

4. The dental implant of claim 1, wherein
the abutment is coupled with the fixture and comprises a polygonal insertion portion, a circular hole, a circular upper groove, and a bottom surface,
the polygonal protruding portion and the polygonal insertion portion have a same polygonal shape such that the polygonal protruding portion is inserted into the polygonal insertion portion to couple the fixture with the abutment, and
the bottom surface is configured to engage with and come into contact with the top surface.

5. The dental implant of claim 4, wherein one or more inclined planes or concave grooves are formed on one or more of an outer circumferential surface of the abutment and the dental prosthesis coupling portion.

6. The dental implant of claim 4, wherein an outer circumferential surface formed on the abutment has a tapered shape or a vertically cylindrical shape.

7. The dental implant of claim 1, further comprising:
a male screw which couples the fixture with the abutment,
wherein
the male screw comprises a head and an external thread, and
a groove having a bar shape, a cross shape, or a polygonal shape is provided on a top surface of the head.

8. The dental implant of claim 2, further comprising:
a male screw which couples the fixture with the abutment,
wherein
the male screw comprises a head and an external thread, and
a groove having a bar shape, a cross shape, or a polygonal shape is provided on a top surface of the head.

9. The dental implant of claim 3, further comprising:
a male screw which couples the fixture with the abutment,
wherein
the male screw comprises a head and an external thread, and
a groove having a bar shape, a cross shape, or a polygonal shape is provided on a top surface of the head.

10. The dental implant of claim 4, further comprising:
a male screw which couples the fixture with the abutment,
wherein
the male screw comprises a head and an external thread, and
a groove having a bar shape, a cross shape, or a polygonal shape is provided on a top surface of the head.

11. The dental implant of claim 1, wherein the gingiva contact portion is formed as a plane which linearly connects an end of a prosthetic margin to the dental root body, or as a curved surface which connects the end of the prosthetic margin to the dental root body using a curve.

12. The dental implant of claim 2, wherein the gingiva contact portion is formed as a plane which linearly connects an end of a prosthetic margin to the dental root body, or as a curved surface which connects the end of the prosthetic margin to the dental root body using a curve.

13. The dental implant of claim 1, wherein the gingiva contact portion has an upper part having a vertically cylindrical part and a lower part having a tapered part.

14. The dental implant of claim 2, wherein the gingiva contact portion has an upper part having a vertically cylindrical part and a lower part having a tapered part.

15. The dental implant of claim 1, wherein the dental prosthesis coupling portion has a length equal to or longer than 1 mm and shorter than 3 mm.

16. The dental implant of claim 2, wherein the dental prosthesis coupling portion has a length equal to or longer than 1 mm and shorter than 3 mm.

17. The dental implant of claim 1, wherein the dental prosthesis coupling portion has an outer surface having a tapered cylindrical shape or a vertically cylindrical shape.

18. The dental implant of claim 2, wherein the dental prosthesis coupling portion has an outer surface having a tapered cylindrical shape or a vertically cylindrical shape.

19. The dental implant of claim 17, wherein the dental prosthesis coupling portion having a vertically cylindrical shape comprises an inclined surface which connects the outer surface to the top surface, or the top surface and the outer surface meet each other at right angles.

20. The dental implant of claim 18, wherein the dental prosthesis coupling portion having a vertically cylindrical shape comprises an inclined surface which connects the outer surface to the top surface, or the top surface and the outer surface meet each other at right angles.
